(19) United States
(12) Patent Application Publication
(10) Pub. No.: US 2005/0156748 A1
(43) Pub. Date: Jul. 21, 2005

(54) Method for notifying of low battery status in a mobile terminal

(75) Inventor: Hyung-Chul Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/924,326

(22) Filed: Aug. 23, 2004

(30) Foreign Application Priority Data
Jan. 16, 2004 (KR) 3370-2004

(51) Int. Cl. G08B 21/00

(52) U.S. Cl. 340/636.1; 713/340

(57) ABSTRACT

A method for notifying of a low battery status in a mobile terminal is disclosed in which remaining battery power is detected while the terminal communicates with another party. If the detected battery power is determined to be reduced to a low battery status, a message for notifying the other party of communication termination due to a low battery status is transmitted the other party. Accordingly, if a mobile terminal enters a low battery status while communicating with the other party, the mobile terminal notifies the other party of communication termination due to the low battery status before forcibly terminating the communication. Thus, the other party can know why the communication was terminated, thereby preventing the other party from attempting unnecessary reconnection.

### PRIORITY

This application claims priority to an application entitled “METHOD FOR NOTIFYING OF LOW BATTERY STATUS IN MOBILE TERMINAL”, filed in the Korean Intellectual Property Office on Jan. 16, 2004 and assigned Serial No. 2004-3370, the contents of which are hereby incorporated by reference.

### BACKGROUND OF THE INVENTION

1. Field of the Invention

The present invention relates to a mobile terminal, and more particularly to a method for operating a mobile terminal when the terminal is turned off due to a low battery status.

2. Description of the Related Art

Generally, if a mobile terminal enters a low battery status in which most of the battery power has been consumed and thus the terminal cannot continue to operate, the terminal is powered off after notifying the user of that terminal of the low battery status.

The mobile terminal may enter such a low battery status while communicating with another party. In this case, the other party will experience an unexpected and abrupt communication termination (i.e. a sudden end to an ongoing call). Since the other party does not know why the communication was abruptly terminated, the other party often tries to reconnect to the terminal. Despite such attempts, the other party cannot reconnect to the terminal since the terminal has already been powered off due to the low battery status.

As described above, if a mobile terminal enters a low battery status while communicating with the other party, communication with the other party is terminated unexpectedly and forcibly, so that the other party is likely to attempt unnecessary reconnection since the other party is unaware of why the communication was terminated.

### SUMMARY OF THE INVENTION

Therefore, the present invention has been made in view of the above problem, and it is an object of the present invention to provide a method for allowing a mobile terminal to notify another, i.e. counterpart, terminal of the terminal's low battery status when the terminal enters the low battery status while communicating with the counterpart.

In accordance with the present invention, there is provided a method for notifying of a low battery status in a mobile terminal, wherein remaining battery power is detected while the terminal communicates with the other party, and if the detected battery power is reduced to a low battery status, a message for notifying the other party of communication termination due to a low battery status is transmitted to the other party.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of a mobile terminal to which the present invention is applied; and

FIG. 2 is a flow chart showing an operation for handling a low battery status in a mobile terminal, according to an embodiment of the present invention.

### DETAILED DESCRIPTION OF THE PREFERRED EMBODIMENTS

Now, preferred embodiments of the present invention will be described in detail with reference to the annexed drawings. In the following description, a detailed description of known functions and configurations incorporated herein is omitted to avoid making the subject matter of the present invention unclear.

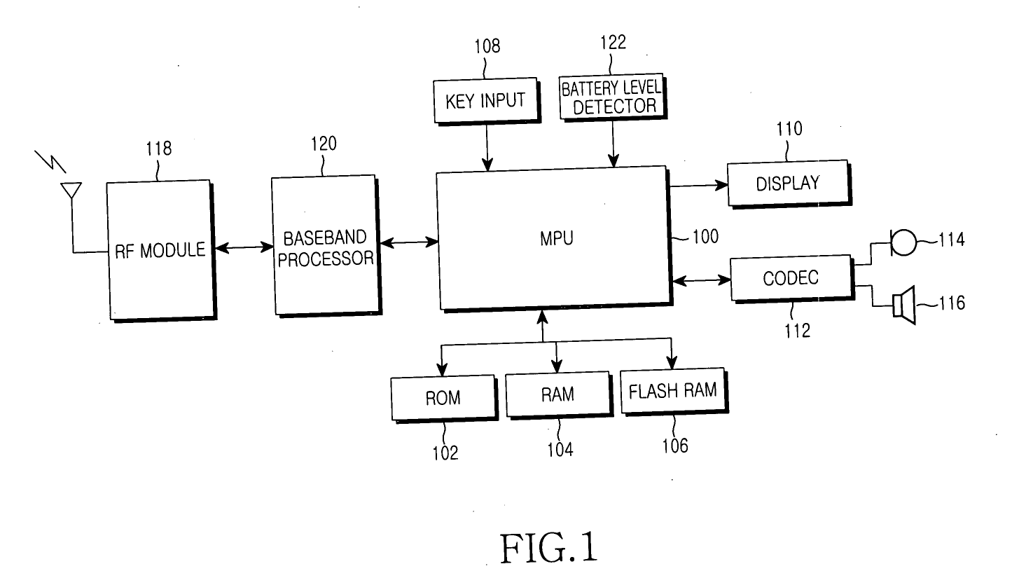

FIG. 1 is a block diagram showing the configuration of a mobile phone as an example of a mobile terminal to which the present invention is applied. In this figure, an MPU (Micro Processor Unit) 100 processes and controls various mobile communication functions such as telephone communication and data communication. A ROM (Read Only Memory) 102 stores a microcode and various reference data of a program for implementing the processing and control of the MPU 100. A RAM (Random Access Memory) 104 is provided as a working memory of the MPU 100. A flash RAM 106 provides an area for storing not only message data but also various updatable data for storage. A key input unit 108 includes number keys from 0 to 9, and various function keys such as “menu”, “select”, “send”, “delete”, “power on/off”, “volume up/down”, “*” and “#”, and provides key input data corresponding to a key pressed by the user to the MPU 100. A display device 110 displays image information according to the control of the MPU 100 on a screen.

A codec (coder-decoder) 112 connected to the MPU 100, and a microphone 114 and a speaker 116 both connected to the codec 112 are used for telephone communication and audio recording. An RF (Radio Frequency) module 118 transmits and receives RF or wireless signals to and from a mobile communication base station (not shown) through an antenna. The RF module 118 modulates a signal for transmission inputted from the MPU 100 through a baseband processor 120 into a RF signal, and transmits the RF signal through the antenna. On the other hand, the RF module 118 demodulates an RF signal received through the antenna, and provides it to the MPU 100 via the baseband processor 120. The baseband processor 120 processes baseband signals to be transmitted and received between the RF module 118 and the MPU 100. A battery level detector 122 detects a power supply voltage of a battery (not shown), and informs the MPU 100 of the detected power supply voltage.

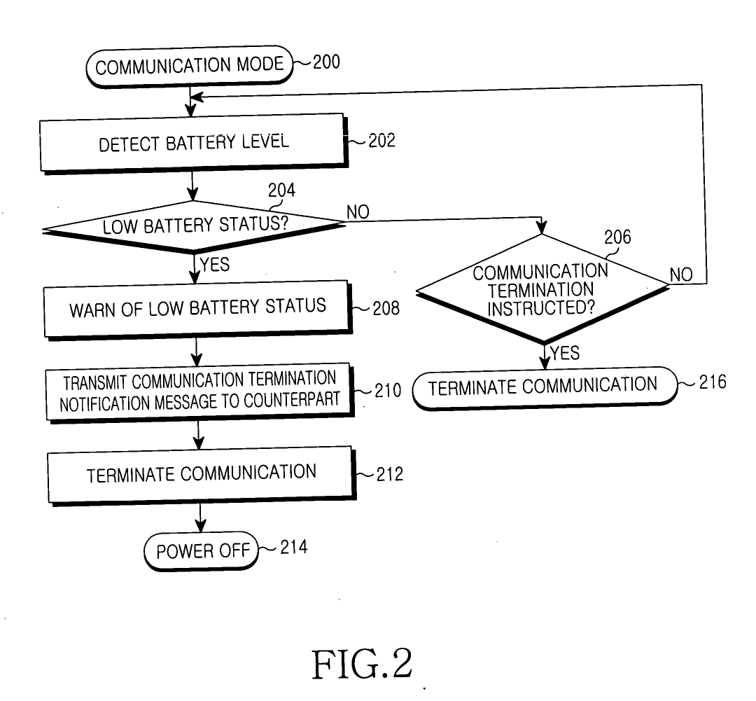

FIG. 2 is a flow chart showing an operation for handling a low battery status in a mobile terminal. As described in steps 200 to 216 of FIG. 2, the MPU 100 is informed of a low battery status in the mobile terminal of FIG. 1, according to an embodiment of the present invention. The mobile terminal enters a communication mode (for example, a phone conversation mode) when it receives or initiates a call at step 200. The MPU 100 detects a battery level to check whether the terminal is entering a low battery status, and checks whether the user or the other party instructs his or her terminal to terminate the communication, at steps 202 to 206.

At step 202, the MPU 100 detects a power supply voltage of the battery via the battery level detector 122 to check whether the terminal is in a low battery status. If, at step 204, the MPU 100 determines that the terminal is not in the low battery status, the MPU 100 checks, at step 206, whether the terminal or the other party instructs his or her terminal to terminate the communication. If the user or the other party does not instruct his or her terminal to terminate the communication, the MPU 100 returns to the step 202. Otherwise, it proceeds to step 216 to terminate the communication (i.e. disconnect the call).

On the other hand, if the checked result at step 204 is that the battery power is reduced to the low battery status, the MPU 100 warns the user of the low battery status at step 208. To warn of the low battery status, the MPU generally instructs the display device 110 to display a warning message and the speaker 116 to output a warning sound.

Thereafter, at step 210, the MPU 100 transmits a message for notifying of communication termination due to a low battery status. The communication termination notification message can be transmitted as a text message or as an audio data, which was previously inputted through the microphone 114, to the other party. The communication termination notification message is an outgoing message (OGM) for notifying the other party that the communication will be terminated due to a low battery status. One exemplary message is “Due to insufficient battery power, the phone conversation will be terminated in a moment.” As indicated above, audio data for such a communication termination notification message has been previously stored in the flash RAM 106 through a recording made by the mobile terminal's user or manufacturer. The stored audio data is read from the flash RAM 106 when the terminal enters the low battery status, and the read data is then transmitted to the other party.

After the communication termination notification message is transmitted to the other party, the MPU 100 operates to terminate the ongoing communication (i.e. disconnects the ongoing call) at step 212 and turns off the power at step 214, in the same manner as the conventional operation for turning off the power due to a low battery status.

As apparent from the above description, according to the present invention, if a mobile terminal enters a low battery status while communicating with the other party, the mobile terminal notifies the other party of communication termination due to the low battery status, which will preclude continued performance of such communication, before forcibly terminating the communication (i.e. disconnecting the call). Thus, the other party is made aware of why the communication was terminated, thereby preventing the other party from attempting unnecessary reconnection.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for providing notification of a low battery status in a mobile terminal, comprising the steps of:
detecting the terminal's remaining battery power while the terminal is in communication with an other party; and
transmitting a communication termination notification message to the other party if the detected battery power is determined to be reduced to the low battery status, wherein said message notifies the other party of communication termination due to the low battery status.

2. The method according to claim 1, further comprising:
terminating the communication after transmitting the message.
